(19) United States
(12) Patent Application Publication
(10) Pub. No.: US 2007/0097893 A1
(43) Pub. Date: May 3, 2007

(54) Method of delivering personalized streaming content via satellite radio

(75) Inventors: Herman Rodriguez, Austin, TX (US); Newton James Smith JR., Austin, TX (US); Clifford Jay Spinac, Austin, TX (US)

Correspondence Address: MARK P. KAHLER, 8101 VAILVIEW COVE, AUSTIN, TX, 78750, US

(73) Assignee: International Business Machines Corporation, Austin, TX (US)

(21) Appl. No.: 11/266,667

(22) Filed: Nov. 3, 2005

(51) Int. Cl. H04B 7/00

(52) U.S. Cl. 370/310; 370/352

(57) ABSTRACT

A method is disclosed for delivering personalized content from a content provider system to a satellite communication receiver user. The user selects content from the content provider system and specifies Internet or satellite delivery. If the user specifies Internet delivery, then the content provider system transmits the selected content to the user via the Internet. However, if the user specifies satellite delivery, then the content provider system acquires the user's satellite communication receiver ID code from the user. The content provider system then transfers the selected content and the user's ID code to a satellite transmitter of a satellite radio provider system. The satellite transmitter transmits the selected content and ID code via a satellite to the user's satellite communication receiver. If the ID code received by the user's satellite communication receiver matches the ID code of this satellite communication receiver, then the satellite communication receiver stores, and allows to the user to access, the selected content.

### TECHNICAL FIELD OF THE INVENTION

The disclosures herein relate generally to communication systems, and more particularly, to satellite communication systems that deliver content to subscribers.

### BACKGROUND

In the last century, content delivery systems progressed from the phonograph to the radio and then to the television. Content users first purchased audio content on vinyl phonograph records for a fee per record. More recently, users purchased audio content on a more compact medium, namely the compact disc or CD. Today, content users may purchase high resolution audio content on digital versatile disks, namely DVD-AUDIO disks or discs with other high resolution formats.

With the advent of the world wide web, namely the “Web” or Internet, specialized audio content web sites began to sell music and audio books on-line. To purchase audio content in this manner, the user typically logs on to a content provider's web site. The user then selects the desired content, pays a fee and then downloads the content via the Web. The user stores the downloaded audio content on a media storage system for later use. Typically, the user's media storage system takes the form of an information handling system (IHS) such as a desktop computer, notebook computer, personal digital assistant (PDA) or other storage device connected to the Internet. Audio content sold by on-line vendors include both music and audio books. In addition to offering music for download wherein the user stores the music for later use, on-line music vendors also offer music in streaming content form wherein the user listens to the music immediately without first storing the music.

Modern satellite system vendors deliver both video and audio content by satellite transmission to ground-based user satellite receivers. Typically the satellite system broadcasts the same encrypted content to all user receivers. However, depending on the user's fee arrangement, the user's receiver employs a key to enable it to decrypt more content of the broadcast for a higher monthly fee and less content of the broadcast for a lower monthly fee.

What is needed is a method and apparatus that provides a more individualized or personalized content to users of satellite receivers.

### SUMMARY

Accordingly, in one embodiment, a method is disclosed for providing content to a satellite communication receiver. The method includes receiving, by a content provider system, a request for selected content and an ID code associated with a particular satellite communication receiver to receive the selected content. The method also includes providing, by the content provider system, the selected content and ID code to a satellite communication transmitter. The method further includes transmitting, by the satellite communication transmitter, the selected content and ID code via a satellite to the satellite communication receiver. In one embodiment, the satellite communication receiver allows access to the selected content if the ID code received by the satellite communication receiver corresponds to the ID code assigned to that satellite communication receiver.

In another embodiment, a method is disclosed for providing content to a satellite communication receiver. The method includes receiving selected content and an ID code, by a satellite communication transmitter, from a content provider system, the ID code being associated with a particular satellite communication receiver. The method also includes transmitting, by the satellite communication transmitter, the selected content and ID code via satellite. The satellite communication receiver receives the selected content and ID code, and allows access to the selected content if the received ID code corresponds to the ID code assigned to that satellite communication receiver.

In yet another embodiment, a communication system is disclosed that includes a communication satellite. The system also includes a satellite communication receiver that receives selected content from the satellite. An ID code is associated with the satellite communication receiver. The system further includes a content provider system that receives a request for selected content and the ID code associated with the satellite communication receiver. The system still further includes a satellite communication transmitter, coupled to the content provider system, that receives the selected content and ID code from the content provider system. The satellite communication transmitter transmits the selected content and ID code to the communication satellite. The communication satellite transmits the selected content and ID code to the satellite communication receiver. The satellite communication receiver allows access to the selected content if the ID code it receives corresponds to the ID code of the satellite communication receiver.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of the disclosed content delivery communication system on which the disclosed content delivery methodology is practiced.

FIG. 2 shows a flowchart that describes process flow in the disclosed communication system of FIG. 1.

### DETAILED DESCRIPTION

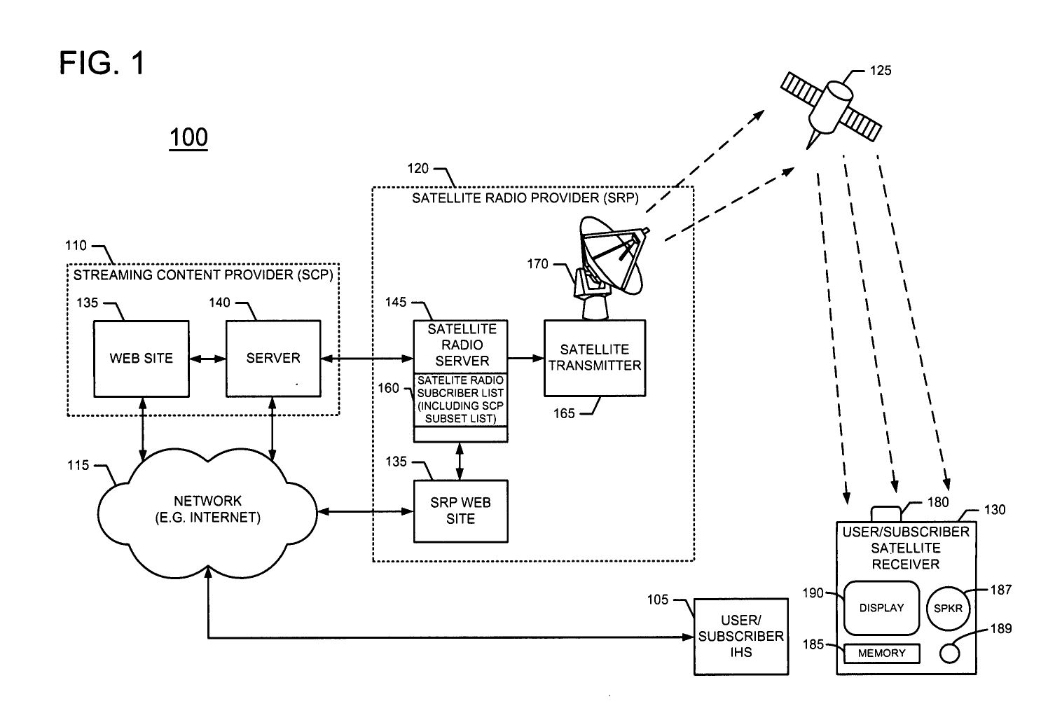

FIG. 1 shows one embodiment of the disclosed content delivery communication system as communication system 100. Communication system 100 includes a user or subscriber information handling system (IHS) 105 from which a user/subscriber may order streaming content from a streaming content provider (SCP) system 110. A network 115, such as the Internet, couples IHS 105 to SCP system 110 to facilitate the order. When placing an order for selected content, the user of IHS 105 may specify delivery of the selected content either by the Internet or satellite as described below in more detail.

The IHS 105 that the user employs to place a content order with SCP system 110 may take the form of a desktop, server, portable, laptop, notebook, or other form factor IHS. For example, IHS 105 may take on other form factors such as a personal digital assistant (PDA), a gaming device, a portable telephone device, a communication device or other devices that include a processor and memory adapted for communication.

Streaming content provider (SCP) system 110 queries the user of user IHS 105 to specify either Internet delivery or satellite delivery of the content the user selects. If the user specifies delivery of the selected content via the Internet, then after accepting the user's payment for the particular selected content item, streaming content provider (SCP) system 110 transmits the selected content to the user's IHS 105 via the Internet 115. In an alternative embodiment, SCP system 110 does not require payment for the selected content item. IHS 105 then downloads the selected content. However, if the user specifies delivery of the selected content via satellite, then SCP system 110 sends the selected content to satellite radio provider (SRP) system 120. In response, SRP system 120 sends the selected content via a satellite 125 orbiting the Earth to the user or subscriber's satellite receiver 130, as described in more detail below. Satellite 125 may be a communication satellite orbiting the Earth in a geosynchronous or other orbit. Satellite 125 may also be a lighter than air vehicle such as a balloon, dirigible or Zeppelin floating in a substantially stationary position above the surface of the Earth.

The selected content that the user orders from content provider 110 may take many forms. For example, the selected content may take the form streaming content such as music files in formats such as WAV, MP3, MP4, AIFF, WMA as well as other formats. The selected content may take the form of audible books, video works or audio/video selections as well.

SCP system 110 includes a web site system 135 that interfaces with the Internet 115. Web site system 135 provides an interface to users or subscribers who desire to register with SCP system 110 to select and place orders for content. Web site system 135 establishes a user ID and password for the user. Web site system 135 couples to a content server 140 that functions as a library or repository of content from which the user may select. The user selects content from content server 140 and pays for the selected content via a Web transaction carried out by Web site system 135. In one embodiment, the user does not pay SCP system 110 for the content. In an alternative embodiment, the user pays satellite radio provider system 120 for content and the satellite provider provides compensation to the streaming content provider for use of its content. During the transaction, the user chooses delivery of the selected content via the Web or via satellite. If the user chooses satellite delivery, content server 140 sends the selected content to a satellite radio server 145 in satellite radio provider (SRP) system 120. The selected content sent to satellite radio server 145 may be audio content, video content or audio/video content. Content server 140 may send the selected content to SRP system 120 via the Internet or other network connection or by other means such as providing a CD ROM, DVD or Flash memory that contains content.

At some point in time, the user of IHS 105 subscribes or otherwise contracts with the satellite service provider that controls and operates SRP system 120. The user of IHS 105 employs a satellite receiver 130 to receive content from satellite radio provider (SRP) system 120 in one embodiment. SRP system 120 assigns a unique ID code, also called an access code, to satellite receiver 130. When the user of a particular satellite receiver 130 employs IHS 105 to register with SCP system 110, the user supplies the unique ID code of receiver 130 to SCP system 110. Such a unique code may include a descriptor that uniquely identifies satellite receiver 130. The user then selects a particular content item via IHS 105. In response, SCP system 110 sends the selected content item and the ID code of the particular associated satellite receiver 130 to satellite radio server 145. Alternatively, instead of placing an order via the Internet, the user may place a phone call to streaming content provider system 110 to select content and provide the user's satellite receiver ID code. In one embodiment, the user may specify the periodic frequency of transmission of the selected content to the user's receiver, for example, daily, weekly or other frequency. Is another embodiment, the user may also specify transmission at a particular time.

As noted above, if during the registration and content selection process with SCP system 110 the user chooses satellite delivery of content rather than Web delivery of content, then content server 140 sends the selected content to a satellite radio server 145 in satellite radio provider (SRP) system 120. Along with the selected content, content server 140 also sends to satellite radio server 145 the unique ID code of the satellite receiver 130 of the user who requested the selected content. Satellite radio server 145 stores a list 160 of all authorized satellite receivers 130. More specifically, list 160 includes the ID codes of all satellite receivers 130 that SRP system 120 authorizes to receive transmissions from SRP system 120. List 160 includes a subset list of those satellite receivers 130 authorized to receive selected content that streaming content provider (SCP) system 110 sends to satellite radio provider (SRP) system. Satellite radio server 145 periodically reviews list 160 and periodically transmits selected content and the corresponding ID code to satellite receivers for a predetermined period of time, or a specified period of time, for example an hour, a day, a week or a month. In other words, satellite radio server 145 transmits and then periodically retransmits the selected content via satellite to the corresponding authorized satellite receiver 130. SRP system 120 thus provides satellite receiver 130 with multiple opportunities to receive transmissions of the selected content.

To actually transmit the selected content item and corresponding ID code to satellite receivers 130, satellite radio server 145 sends the selected content item and the ID code of the requesting satellite receiver 130 to satellite transmitter 165. Satellite transmitter 165, typically located at a ground station located on Earth, then employs satellite antenna 170 to send the selected content item and ID code to the requesting satellite receiver 130 via satellite transmit antenna 170 and the satellite 125.

Satellite receiver 130 receives satellite signals from satellite 125 via satellite receive antenna 180 and checks the received signals to determine if receiver 130 is authorized to access the selected content item contained therein. More particularly, in one embodiment, satellite receiver 130 checks to see if its receiver ID code matches the receiver ID code received with the selected content item. If the two ID codes match, then satellite receiver 130 decrypts or otherwise accesses and stores the selected content item in non-volatile memory 185 for later playback through audio speaker 187. Satellite receiver 130 includes controls 189 and a display 190 to facilitate the playing or playback of the selected content item. More particularly, controls 189 includes controls for manipulating the selected content such as stop, play, pause, fast forward, rewind, delete selected content to free memory 185 and receive next selected content item, for example. In the present embodiment, satellite receiver 130 stores the selected content item in memory 185 for later use. If the selected content item includes audio content, then the user employs controls 189 to play the content item through speaker 187 at a later time. However, if the selected content item is an audio-video content item, then the user employs controls 189 to play the audio portion of the content through speaker 187 and display 190 to play the video portion of the content. Alternatively, satellite receiver 130 may stream the selected content item directly to speaker 187 and display 190 immediately upon reception if the user so selects via controls 189.

In another embodiment, system 100 provides a second layer of encryption beyond any encryption that SCP 110 and SRP 120 may employ using the ID code of satellite receiver 130 as a key. For example, satellite receiver 130 may include a menu option that appears on display 190 to allow the user to select a user key by using controls 189. The user sends the user-specified key to streaming content provider (SCP) system 110 when selecting content from SCP system 110. SCP system 110 employs the user-specified key to encrypt the selected content that SCP system 110 sends to SRP system 120. Again, this encryption with the user-specified key is in addition to any other encryption provided by SCP system 110 or SRP system 120 and any intervening or external relay stations. Upon receiving the selected content, receiver 130 uses the user-specified key associated with that receiver 130 to decrypt the encrypted content.

In one embodiment, satellite radio provider (SRP) system 120 includes an SRP web site system 135 coupled to satellite radio server 145. In such an embodiment, a user or subscriber of a satellite receiver such as receiver 130 may access the SRP system 120 via IHS 105 and the Internet 115 to register for content directly from the satellite radio provider rather than from the streaming content provider of SCP system 110. In this embodiment, server 145 stores a library of audio, video or audio/video content that the user of satellite receiver 130 may request for satellite delivery.

In one embodiment, the streaming content provider associated with streaming content provider system 110 and the satellite radio provider associated with satellite radio provider system 120 are different business entities. Streaming content provider system 110 and satellite radio provider system 120 may be located in different physical locations. Alternatively, streaming content provider system 110 and satellite radio provider system 120 may be substantially co-located. As used herein, the term satellite radio provider may include providers of audio, video and audio/video content.

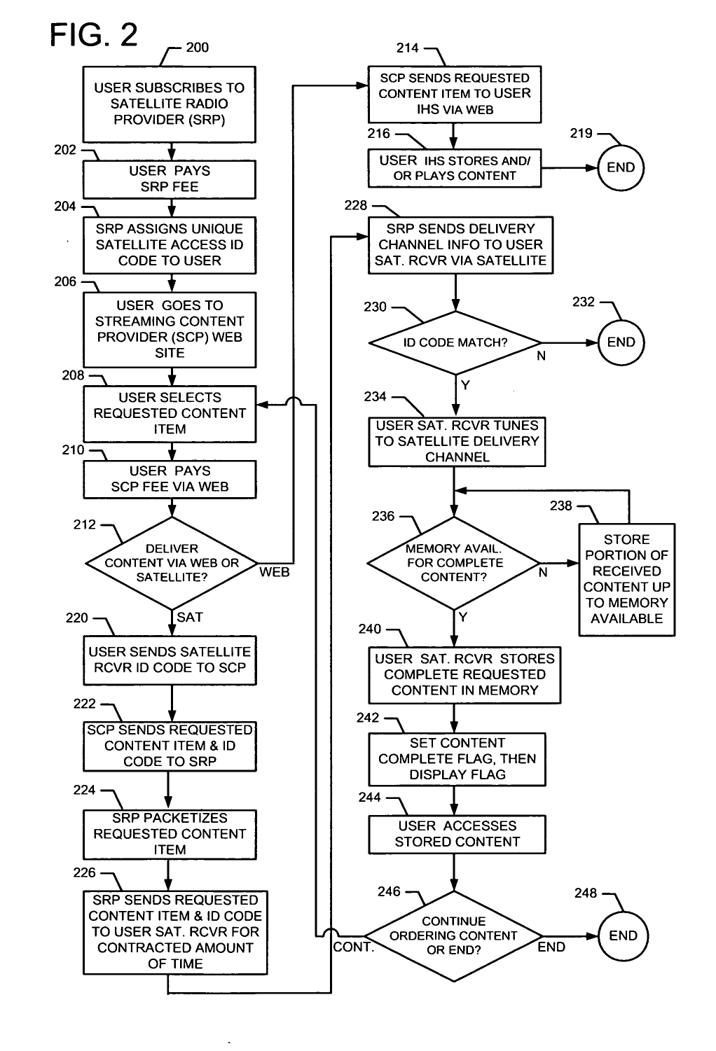

FIG. 2 is a flowchart that depicts process flow in the operation of content delivery communication system 100. In one embodiment, a satellite radio user or subscriber subscribes to a satellite radio service as per block 200. For example, a user may acquire a satellite radio receiver 130 by paying a fee as per block 202. A user employs IHS 105 to log on to SRP web site 135 to register satellite radio receiver 130. The user may contract with the satellite radio provider for satellite radio service for a monthly or yearly fixed fee, in one embodiment. SRP web site 135 then sends a unique access ID code over Internet 115 to the user's IHS 105 as per block 204. The user then enters this ID code into satellite receiver 130. In another embodiment, a user pays a third-party to provide a satellite receiver 130 with the unique ID code already programmed therein. In yet another embodiment, the user may place a phone call to the satellite radio provider to set up an account with a monthly, yearly or other billing arrangement. In return, the satellite radio provider then pre-programs a satellite receiver 130 with a unique ID code and sends the pre-programmed satellite receiver 130 to the user. In still another embodiment, over the air programming via satellite may provide a newly registered satellite receiver 130 with a unique ID code.

The user then employs IHS 105 to access the web site 135 of the streaming content provider system 110 via Internet connection 115 as per block 206. The user reviews the library in content server 140 and selects a content item as per block 208. The user may authorize payment of a fee to the streaming content provider via the Internet or Web connection as per block 210. If desired, the user may perform this transaction over a telephone connection with the content provider rather than an Internet connection. The user then makes a decision and instructs content provider system 110 to deliver content either via the Internet/Web or via satellite radio as per decision block 212. If the user selects an Internet/Web connection as the content delivery vehicle, then process flow continues to block 214 at which streaming content provider (SCP) system 110 sends the selected content item directly to user IHS 105 via the Internet 115. The user IHS 105 then stores and/or plays the selected content item as per block 216 and the process ends at block 219. If the user desires, the user may at any time return to block 208 and order more content.

Alternatively, if the user selects satellite radio at decision block 212 as the content delivery vehicle, then as part of the registration process the user provides his or her satellite receiver's unique ID code to content provider system 110 as per block 220. For example, user system 105 sends the satellite receiver ID code of the user to content provider system 110. Content provider system 110 subsequently sends the selected content item and the ID code of the associated satellite receiver 130 to satellite radio provider (SRP) system 120 as per block 222. Satellite radio provider system (SRP) 120 performs a format conversion on the selected content item. For example SRP system 120 packetizes the selected content item as per block 224. SRP system 120 then sends the packetized selected content item and the ID code of receiver 130 to satellite transmitter 165 which transmits the content item and ID code to a universe of satellite receivers, of which satellite receiver 130 is one, as per block 226. SRP system 120 continues to transmit the content item and ID code periodically for a predetermined contracted amount of time. SCP system 110 and SRP system 120 may use the ID code to encrypt the content item. SRP system 120 also transmits delivery channel information via satellite 125 as per block 228. Each satellite receiver performs a test to determine if it is authorized to access the selected content item. More particularly, satellite receiver 130 performs a test to determine if the ID code it receives from SRP system 120 matches this satellite receiver's own ID code as per decision block 230. If the received ID code does not match the ID code of a particular satellite receiver, then the process ends at block 232. However, if the ID code of a particular satellite receiver 130 matches the received ID code, then process flow continues to block 234. At block 234, the authorized satellite receiver 130 having the correct ID code tunes to the particular satellite delivery channel identified in the previous transmission of delivery channel information in block 228.

The authorized satellite receiver 130 conducts a test to determine if non-volatile memory 185 currently exhibits sufficient free memory space to store the selected content item as per decision block 236. If memory 185 includes insufficient space for storage of the complete content item, then satellite receiver 130 receives the selected content item and memory 185 stores a portion of the content item up to the amount of memory space available as per block 238. Process flow continues back to the input of decision block 236 that waits for memory 185 to exhibit sufficient space to store the entire received content item or the remaining portion of the content item. Since SRP system 120 transmits the selected content item periodically during the contracted amount of time, memory 185 may store remaining portions of the selected content item received during later transmissions and receptions of the selected content item. Storage of the received selected content item completes in block 240. Upon such completion of reception and storage, satellite receiver 130 sets a ready flag therein to note completion of reception as per block 242. Satellite receiver 130 displays ready flag information on display 190 to let the user know that receiver 130 completed storage of the selected content item also as per block 240. The displayed ready flag information notifies the user that the selected content item is ready for use. The display flag may indicate receipt of the full transmission of the selected content item or a usable portion thereof. The user then accesses the stored content as per block 244. If the stored content is audio content, then the user may manipulate controls 189 to cause the audio content to play through loudspeaker 187. If the stored content is audio-video content, then the user may manipulate controls 189 to cause the audio-video content to play on display 190 and through loudspeaker 187. The user then makes a decision to end the process or continue ordering more content as per decision block 246. If the user elects to stop ordering content then the process ends as per block 248. The user may play the recorded content at a later time. However, if the user elects to order more content, then the user may contact content provider system via user IHS 105, via phone or other communication mechanism. The user orders the new selected content at block 208 and pays the requisite fee at block 210. Then the process continues as before as shown in FIG. 2.

The foregoing discloses a methodology and system for ordering, requesting and delivering content via satellite radio. In one embodiment, the user orders or requests content from a content provider system that sends the content ordered by the user to a satellite provider system that transmits the ordered content to the user's satellite receiver. In this manner, the system supplies the user with personalized content.

Modifications and alternative embodiments of this invention will be apparent to those skilled in the art in view of this description of the invention. Accordingly, this description teaches the manner of carrying out the invention and is intended to be construed as illustrative only. Portions of the disclosed technology may be embodied in software, firmware or hardware, or a combination thereof. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of providing content to a satellite communication receiver, the method comprising:
receiving, by a content provider system, a request for selected content and an ID code associated with a particular satellite communication receiver to receive the selected content;
providing, by the content provider system, the selected content and ID code to a satellite communication transmitter;
transmitting, by the satellite communication transmitter, the selected content and ID code via a satellite to the satellite communication receiver; and
receiving, by the satellite communication receiver, the selected content and ID code from the satellite.

2. The method of claim 1, further comprising, the satellite communication receiver allowing access to the selected content if the ID code received by the satellite communication receiver matches the ID code associated with the satellite communication receiver.

3. The method of claim 2, further comprising displaying, by the satellite communication receiver, an indication that the selected content is ready for use.

4. The method of claim 1, wherein the receiving a request for selected content further comprises receiving the request for selected content via the Internet.

5. The method of claim 1, further comprising querying a user via the Internet, by the content provider system, to determine if the user desires the selected content to be transmitted to the user via the satellite communication transmitter.

6. The method of claim 1 wherein the satellite communication transmitter transmits the selected content as streaming content.

7. The method of claim 6 wherein the streaming content comprises one of audio content, video content and audio/video content.

8. A method of providing content to a satellite communication receiver, the method comprising:
receiving selected content and an ID code, by a satellite communication transmitter, from a content provider system, the ID code being associated with a particular satellite communication receiver;
transmitting, by the satellite communication transmitter, the selected content and ID code via a satellite; and
receiving, by a satellite communication receiver, the selected content and ID code from the satellite.

9. The method of claim 8, further comprising the satellite communication receiver allowing access to the selected content if the ID code received by the satellite communication receiver matches the ID code associated with the satellite communication receiver.

10. The method of claim 9, further comprising displaying, by the satellite communication receiver, an indication that the selected content is ready for use.

11. The method of claim 8 wherein the satellite communication transmitter transmits the selected content as streaming content.

12. The method of claim 11 wherein the streaming content comprises one of audio content, video content and audio/video content.

13. A method of providing content to a user comprising:
querying the user, by a content provider system, to determine if the user desires delivery of selected content via satellite or via the Internet;
transmitting, by the content provider system, the selected content to the user via the Internet responsive to the user selecting satellite delivery; and
transmitting, by the content provider system, to a satellite communication transmitter the selected content and an ID code of a satellite communication receiver, if the content provider system determines that the user chooses satellite transmission of the selected content.

14. The method of claim 13, further comprising transmitting, by the satellite communication transmitter, the selected content and the ID code via a satellite to the satellite communication receiver.

15. The method of claim 14, further comprising receiving, by the satellite communication receiver, the selected content and ID code from the satellite, the satellite communication receiver allowing access to the selected content if the ID code received by the satellite communication receiver corresponds to an ID code assigned to the satellite communication receiver.

16. The method of claim 16, further comprising storing, by the satellite communication receiver, the selected content in a memory in the satellite communication receiver.

17. The method of claim 17, further comprising displaying, by the satellite communication receiver, an indication that the selected content is ready for use.

18. A communication system comprising:
a communication satellite;
a satellite communication receiver that receives selected content from the satellite, the satellite communication receiver having an ID code associated therewith;
a content provider system that receives a request for selected content and the ID code associated with the satellite communication receiver; and
a satellite communication transmitter, coupled to the content provider system, that receives the selected content and ID code from the content provider system, the satellite communication transmitter transmitting the selected content and ID code to the communication satellite, the communication satellite transmitting the selected content and ID code to the satellite communication receiver.

19. The communication system of claim 18, wherein the satellite communication receiver receives the selected content and ID code, and the satellite communication receiver allows access to the selected content if the ID code received by the satellite communication receiver matches the ID code associated with the satellite communication receiver.

20. The communication system of claim 18, wherein the satellite receiver includes a display that displays an indication that the selected content is ready for use.
